(19) United States
(12) Patent Application Publication
(10) Pub. No.: US 2020/0240830 A1
(43) Pub. Date: Jul. 30, 2020

(54) WEIGHT SCALE, METHOD OF MEASURING WEIGHT, AND ANIMAL LITTER BOX

(71) Applicant: Sharp Kabushiki Kaisha, Sakai City, Osaka (JP)

(72) Inventor: NOBUYUKI ASAHARA, Sakai City, Osaka (JP)

(21) Appl. No.: 16/633,835

(22) PCT Filed: Jul. 20, 2018
(86) PCT No.: PCT/JP2018/027301

§ 371 Date: Jan. 24, 2020

(30) Foreign Application Priority Data
Jul. 28, 2017 (JP) 2017-147089

(51) Int. Cl. G01G 19/52; G01G 3/142; A01K 1/01; A01K 29/00

(52) U.S. Cl. CPC G01G 19/52; A01K 29/00; A01K 1/0107; G01G 3/142

(57) ABSTRACT

A weight scale includes a load cell, an amplifier, an A/D converter, and a CPU that includes: a determining unit configured to determine whether the measurement target is a heavy object or a light object; and a classified weight measurement control unit configured to set up the amplifier, based on the determining as to whether the measurement target is the heavy object or the light object, for a measurement range narrower than a maximum measurement range of the amplifier and also for an amplification factor larger than an amplification factor used with the maximum measurement range, so as to match the heavy object or the light object, and thereafter cause the amplifier to amplify an output voltage of the load sensor and the A/D converter to convert an output of the amplifier from analog to digital, to obtain a weight value of the measurement target.

### TECHNICAL FIELD

The present invention relates to weight scales, methods of measuring weight, and animal litter boxes (toilets), including a load cell or like load sensor, an amplifier, and an A/D converter.

### BACKGROUND ART

Patent Literature 1 discloses an exemplary conventional automatic companion animal body weight measuring system for conveniently and accurately measuring the body weight of a companion animal. The automatic companion animal body weight measuring system includes: weight measuring means, installed below a living space for a companion animal, for measuring the weight of the living space with or without a companion animal in the living space; and weight calculating means for calculating and displaying the weight of the companion animal on the basis of the degree of change of the living space weight data outputted by the weight measuring means.

Patent Literature 1 also describes that if the living space for the companion animal is a toilet, the automatic companion animal body weight measuring system measures the weight of excreta of the companion animal from a difference between the weight of the living space before the companion animal moves onto the living space and the weight of the living space after the companion animal has moved down from the living space following urination and/or defecation.

### CITATION LIST

### Patent Literature

Patent Literature 1: Japanese Unexamined Patent Application Publication, Tokukai, No. 2007-330200 (Publication Date: Dec. 27, 2007)

### SUMMARY OF INVENTION

### Technical Problem

The automatic companion animal body weight measuring system disclosed in Patent Literature 1 listed above includes a weight scale located below a living space (e.g., bed or toilet) for a companion animal, enabling easy measurement of the companion animal's body or excreta weight when the companion animal moves into the living space.

However, the companion animal toilet system described above having a conventional weight measuring function measures both the body weight and the excreta weight by using the same weight scale and the same measurement range. The system therefore has disadvantageously low precision in excreta weight measurement. Achieving high-precision measurement using a weight scale that provides a wide measurement range requires high-precision amplifiers and high-resolution analog-to-digital converters. These electric components are costly.

The present invention, in an aspect thereof, has been made in view of this conventional issue and has an object to provide a weight scale, a method of measuring weight, and an animal litter box that can improve measurement precision at low cost in both heavy object measurement and light object measurement.

### Solution to Problem

To address the issue, the present invention, in an aspect thereof, is directed to a weight scale including: a load sensor; an amplifier; an A/D converter; and a control unit that controls these components to calculate weight of a measurement target, the control unit including: a determining unit configured to determine whether the measurement target is a heavy object or a light object that is lighter in weight than the heavy object; and a classified weight measurement control unit configured to set up the amplifier, based on the determining as to whether the measurement target is the heavy object or the light object, for a measurement range narrower than a maximum measurement range of the amplifier and also for an amplification factor larger than an amplification factor used with the maximum measurement range, so as to match the heavy object or the light object, and thereafter cause the amplifier to amplify an output voltage of the load sensor and the A/D converter to convert an output of the amplifier from analog to digital, to obtain a weight value of the measurement target.

To address the issue, the present invention, in an aspect thereof, is directed to a method of measuring weight of a measurement target by using a load sensor, an amplifier, and an A/D converter, the method including the determining step of determining whether the measurement target is a heavy object or a light object that is lighter in weight than the heavy object, wherein the method sets up the amplifier, based on the determining as to whether the measurement target is the heavy object or the light object, for a measurement range narrower than a maximum measurement range of the amplifier and also for an amplification factor larger than an amplification factor used with the maximum measurement range, so as to match the heavy object or the light object, and thereafter causes the amplifier to amplify an output voltage of the load sensor and the A/D converter to convert an output of the amplifier from analog to digital, to obtain a weight value of the measurement target.

To address the issue, the present invention, in an aspect thereof, is directed to an animal litter box including the weight scale described above to measure weight of either an animal or excreta of the animal or both.

### Advantageous Effects of Invention

The present invention, in an aspect thereof, advantageously provide a weight scale, a method of measuring weight, and an animal litter box that can improve measurement precision at low cost in both heavy object measurement and light object measurement.

### BRIEF DESCRIPTION OF DRAWINGS

FIG. 1 is a flow chart representing a flow of measurement of the body or excreta weight of the measurement-target companion animal by using a weight scale in accordance with Embodiment 1 of the present invention.

Portion (a) of FIG. 2 is a perspective view of a companion animal litter box including such a weight scale, and (b) of FIG. 2 is an exploded perspective view of the companion animal litter box.

FIG. 3 is a cross-sectional view of the companion animal litter box.

FIG. 4 is a block diagram of a configuration of a control device for the companion animal litter box.

Portion (a) of FIG. 5 is a graph representing an output, in a first round of measurement, of a built-in load cell in a weight scale provided in the companion animal litter box, (b) of FIG. 5 is a graph representing an output of an amplifier, and (c) of FIG. 5 is a graph representing an output of an A/D converter.

Portion (a) of FIG. 6, illustrating how weight is measured twice on the weight scale in the companion animal litter box to achieve a higher level of precision, is a graph representing an output of an amplifier when a first measurement of 10 kg is obtained using a load cell that has a rating of 20 kg, and (b) of FIG. 6 is a graph representing an output of an A/D converter.

Portion (a) of FIG. 7, illustrating how weight is measured twice on the weight scale in the companion animal litter box to achieve a higher level of precision, is a graph representing an output of an amplifier when a first measurement of 5 kg is obtained using a load cell that has a rating of 20 kg, and (b) of FIG. 7 is a graph representing an output of an A/D converter.

FIG. 8 is a graph representing a relationship between time and weight when the body or excreta weight of the measurement-target companion animal is measured on the weight scale in the companion animal litter box.

FIG. 9 is a block diagram of a configuration of a control device for a companion animal litter box in relation to a weight scale in accordance with Embodiment 2 of the present invention.

FIG. 10 is a flow chart representing a flow of measurement of the body or excreta weight of the measurement-target companion animal by using the weight scale in the companion animal litter box.

Portion (a) of FIG. 11 is a graph representing a relationship between time and weight when the body or excreta weight of the measurement-target companion animal is measured, and (b) of FIG. 11 is a graph representing a relationship between time and acceleration when the body or excreta weight of the measurement-target companion animal is measured.

FIG. 12 is a flow chart representing a flow of successively measuring the body and excreta weights of the measurement-target companion animal by using a weight scale in a companion animal litter box in accordance with Embodiment 3 of the present invention.

FIG. 13 is a graph representing a relationship between time and weight when the body and excreta weights of the measurement-target companion animal are measured.

### DESCRIPTION OF EMBODIMENTS

### Embodiment 1

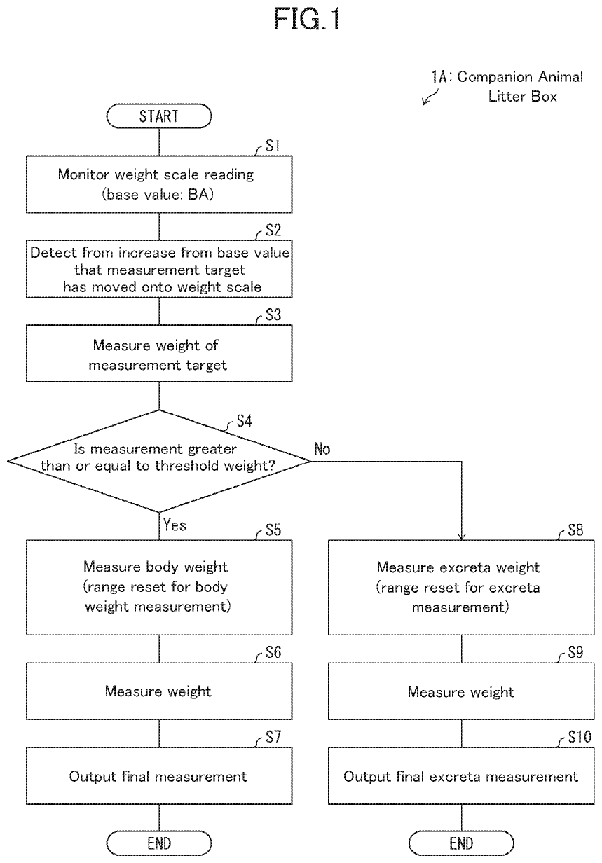

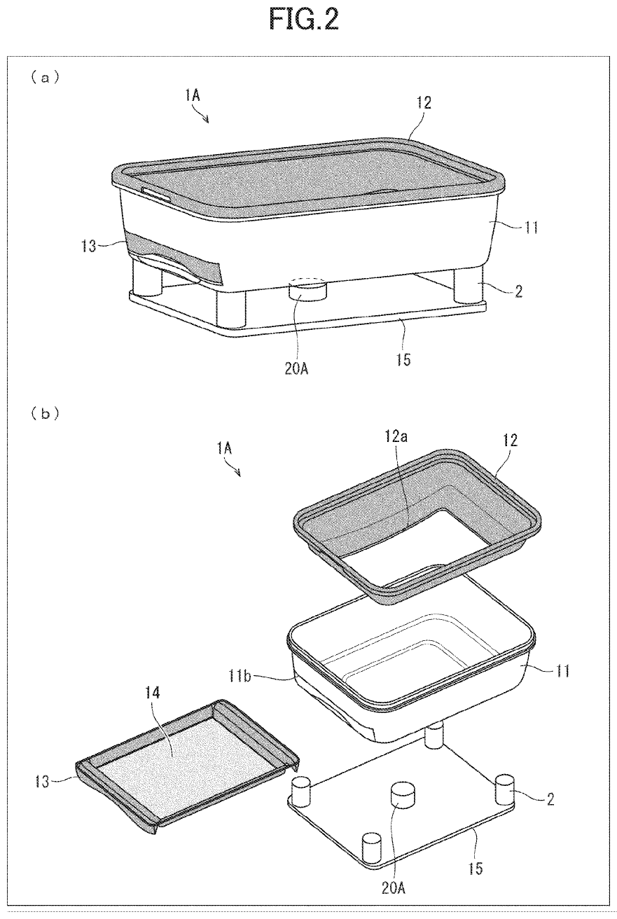

The following will describe an embodiment of the present invention with reference to FIGS. 1 to 8.

A companion animal litter box, as an animal litter box including a weight scale in accordance with the present embodiment, is a companion animal toilet that measures the body weight of a companion animal as an animal and that also measures the weight of the excreta excreted by the companion animal Examples of companion animals may include domestic animals such as cats and dogs. In some aspects of the present invention, the animal litter box is not necessarily used by a cat or dog and may be used by other animals. Excreta may be either urine or feces.

### Structure of Companion Animal Litter Box

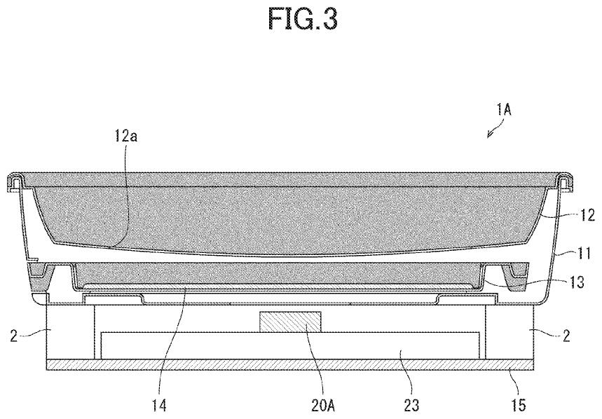

Referring to (a) and (b) of FIG. 2 and FIG. 3, a description will be now given of a structure of a companion animal litter box 1A, as an animal toilet, including a weight scale in accordance with the present embodiment. Portion (a) of FIG. 2 is a perspective view of the companion animal litter box 1A including weight scales 2 in accordance with the present embodiment. Portion (b) of FIG. 2 is an exploded perspective view of the companion animal litter box 1A. FIG. 3 is a cross-sectional view of the companion animal litter box 1A.

The companion animal litter box 1A in accordance with the present embodiment functions as a weight measuring device for measuring the body and excreta weights of a companion animal which is an animal as shown in (a) and (b) of FIG. 2 and FIG. 3. The companion animal litter box 1A includes a main body container 11, a scale tray 12, a litter tray 13, an absorbent sheet 14, a support unit 15, the weight scales 2, a control device 20A, and a cover (not shown).

The main body container 11 holds the scale tray 12 and the litter tray 13 containing the absorbent sheet 14.

The scale tray 12 provides a platform for a companion animal to sit or stand on for urination and/or defecation. The scale tray 12 has an opening 12a through the bottom thereof. The excreta excreted by the companion animal falls onto the absorbent sheet 14 spread in the litter tray 13. The scale tray 12 is shaped like a hollow container in the present embodiment, but may take any shape so long as the scale tray 12 permits an animal to sit or stand thereon for measurement of its body weight.

The litter tray 13 is disposed below the scale tray 12 to receive excreta. The litter tray 13 can be put into, and taken out of, the main body container 11 through a side hole 11b opened in a side face of the main body container 11.

The absorbent sheet 14 absorbs liquids such as urine. The absorbent sheet 14 is convenient in that it can be discarded and replaced with a new one after absorbing a liquid such as urine, but not essential to the invention.

The support unit 15 is a foundation plate supporting the weight scales 2. The support unit 15, in the present embodiment, carries thereon the control device 20A substantially at the center of the support unit 15.

The weight scales 2 support the main body container 11 containing the scale tray 12. In the present embodiment, as an example, there are provided four weight scales 2, one for each corner of the bottom of the main body container 11 in such a manner that the weight scale 2 is in contact with the corner. The weight scales 2 each includes, for example, a load cell. The load cells in the weight scales 2 hence measure the total weight of the animal or excreta and the main body container 11 including the scale tray 12 and the litter tray 13 containing the absorbent sheet 14. The weight scales 2 output weight measurements to the control device 20A.

The weight scales 2, in the present embodiment, each include a load cell as a load sensor. The load cell detects a change in voltage that results from a change in resistance under strain. The load cell outputs analog values. Digitization of these values therefore usually necessitates an amplifier and an A/D converter. In an aspect of the present invention, however, the load sensor is not necessarily a load cell and may be, for example, an electromagnetic weight scale. An electromagnetic weight scale exploits electromagnetic force to balance the scale and detects an electric current when the scale is balanced. This type of weight scale also outputs analog values. Therefore, electromagnetic weight scales also generally need an amplifier and an A/D converter to generate digital outputs.

### Configuration of Control Device

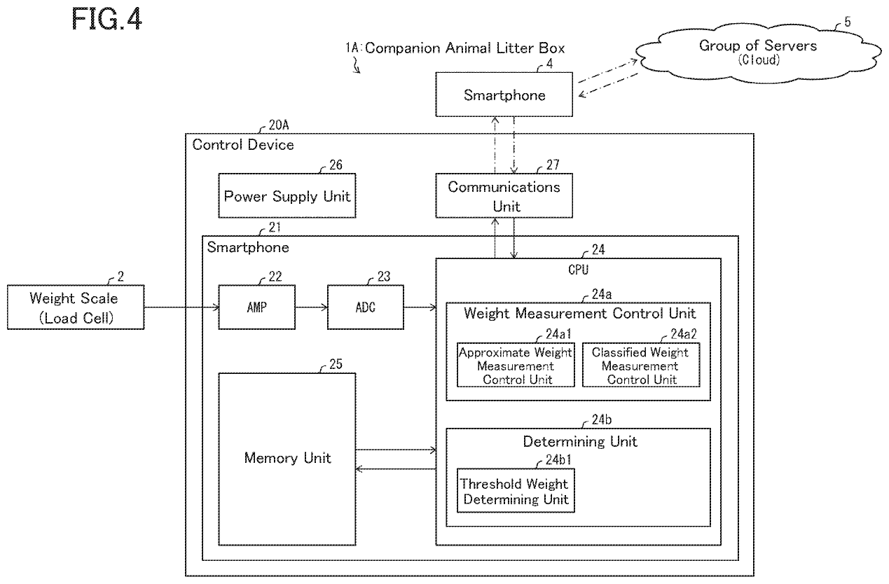

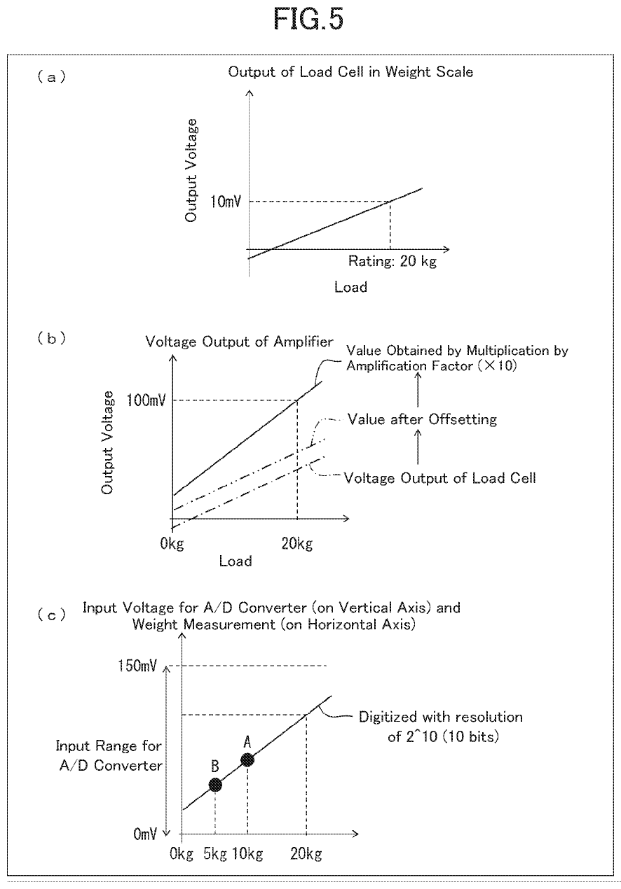

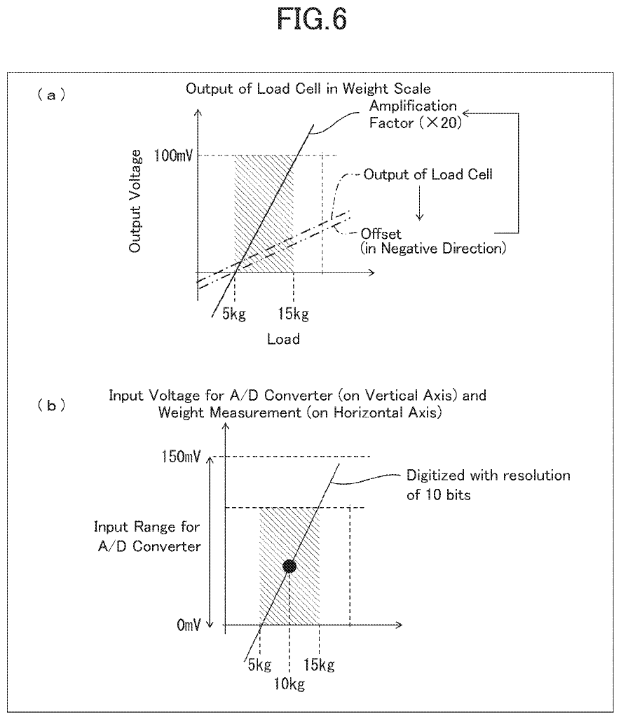

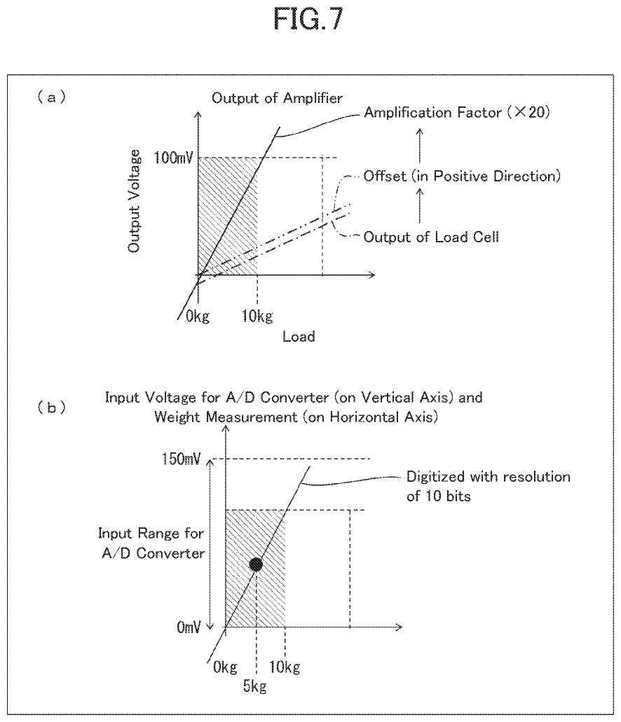

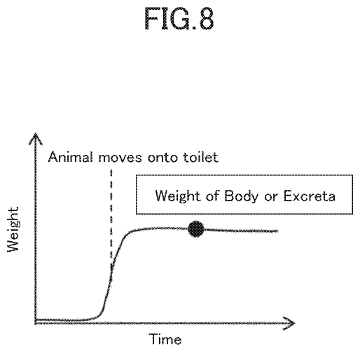

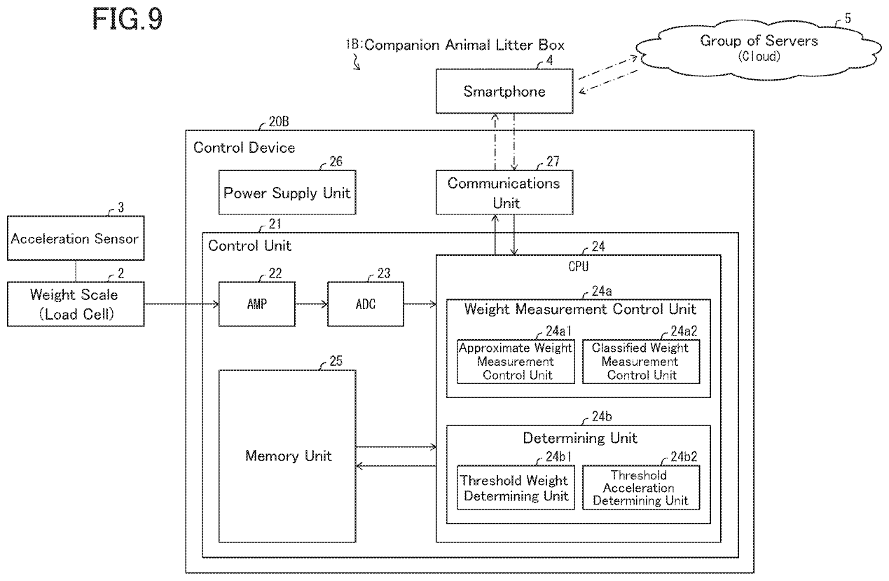

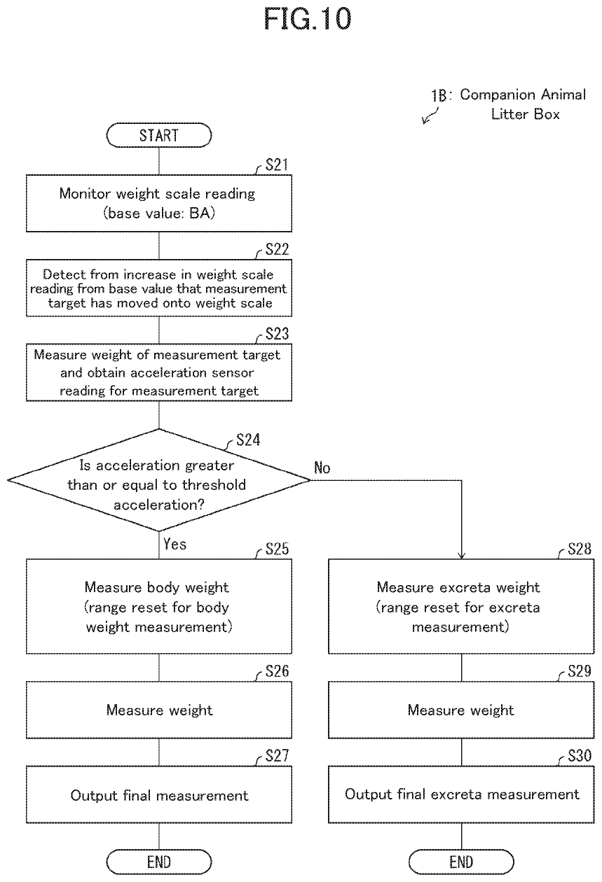

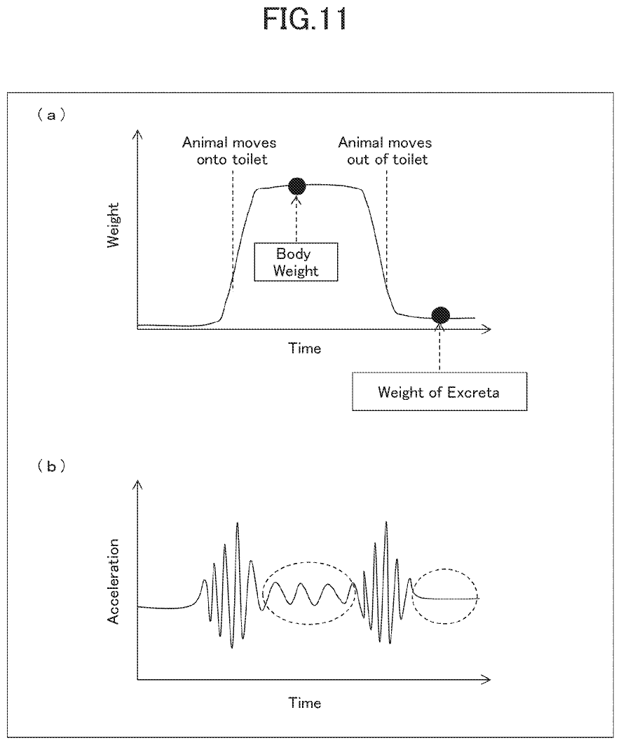

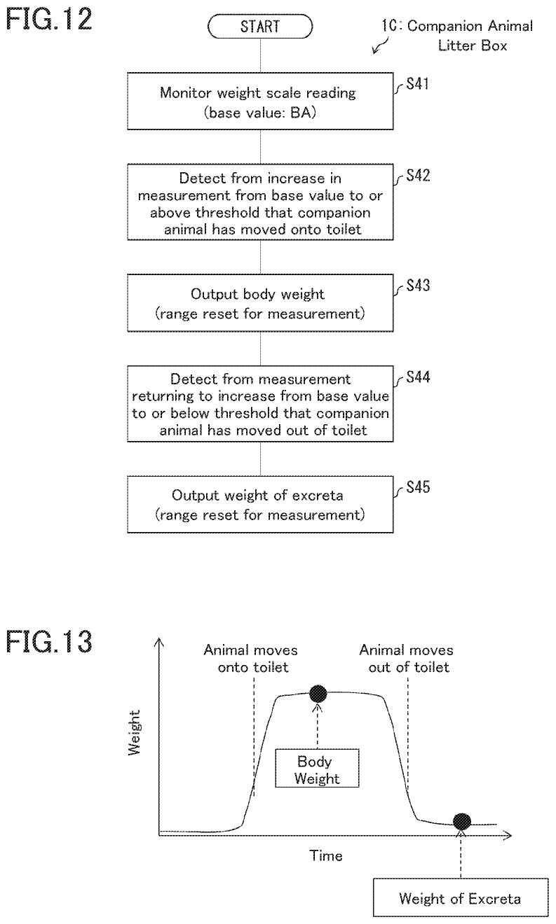

A description will be given of a configuration of the control device 20A in the companion animal litter box 1A in accordance with the present embodiment with reference to FIG. 4. FIG. 4 is a block diagram of a configuration of the control device 20A in the companion animal litter box 1A in accordance with the present embodiment.

Referring to FIG. 4, the control device 20A includes a control unit 21, a power supply unit 26, and a communications unit 27. The control unit 21 includes an amplifier 22, an analog-to-digital converter (A/D converter) 23, a central processing unit (CPU) 24, and a memory unit 25.

The CPU 24, in the present embodiment, includes a weight measurement control unit 24a and a determining unit 24b to measure weight.

The weight measurement control unit 24a, in the present embodiment, includes an approximate weight measurement control unit 24a1 and a classified weight measurement control unit 24a2.

The approximate weight measurement control unit 24a1 sets up the amplifier 22 for a first measurement range, which is a maximum measurement range, and a first amplification factor that matches the maximum measurement range in a first round of weight measurement and causes the amplifier 22 to amplify an output voltage of the load cell and the A/D converter 23 to convert an output of the amplifier 22 from analog to digital, to obtain an approximate weight of the measurement target. This configuration enables approximate weight measurement on the measurement target albeit with moderate precision.

The classified weight measurement control unit 24a2 sets up the amplifier 22 for a measurement range narrower than the maximum measurement range of the amplifier 22 and an amplification factor larger than that used with the maximum measurement range on the basis of a determination by the determining unit 24b as to whether the measurement target is a heavy object or a light object, so as to match the heavy object or the light object. The classified weight measurement control unit 24a2 then causes the amplifier 22 to amplify an output voltage of the load cell and the A/D converter 23 to convert an output of the amplifier 22 from analog to digital, to obtain a weight value of the measurement target.

The determining unit 24b determines whether the measurement target is a heavy object or a light object that is lighter in weight than the heavy object, in other words, determines whether the measurement target is the body weight of a companion animal (heavy object) or the weight of excreta (light object) of the companion animal.

In the present embodiment, the determining unit 24b includes a threshold weight determining unit 24b1. The threshold weight determining unit 24b1 determines, by using a threshold weight of, for example, 500 grams, whether a companion animal or excreta is currently in the main body container 11. The threshold weight is determined to fall between the body weight of the companion animal and the weight of excreta of the companion animal. Accordingly, if the weight scales 2 give a measurement greater than or equal to the threshold weight for the measurement target currently in the main body container 11, it is determined that the companion animal is in the main body container 11. On the other hand, if the weight scales 2 give a measurement greater than zero and smaller than the threshold weight for the measurement target currently in the main body container 11, the threshold weight determining unit 24b1 determines that excreta of the companion animal is in the main body container 11. A measurement of 0 given by the weight scales 2 indicates that there is nothing in the main body container 11.

A description will be given next of control for obtaining approximate weight measurements of the body and excreta of the companion animal as implemented by the approximate weight measurement control unit 24a1 and the threshold weight determining unit 24b1.

The approximate weight measurement control unit 24a1 and the threshold weight determining unit 24b1 perform the following control to measure the body weight of the companion animal. If the threshold weight determining unit 24b1 determines that the measurements from the weight scales 2 are greater than or equal to the threshold weight, it is determined that a companion animal has moved onto the main body container 11. In this situation, the measurements from the weight scales 2 indicate the total weight of the main body container 11 and the companion animal. When there is no companion animal in the main body container 11, the companion animal has a zero weight. When the companion animal has a zero weight, the measurements indicate the weight of the litter tray 13 containing the absorbent sheet 14 and the main body container 11 supporting the scale tray 12. In this example, this weight will be referred to as “base value” (reference value) BA, which means the tare weight. The weight measurement control unit 24a can accordingly determine, as the weight of the companion animal, the difference between the measurements from the weight scales 2 obtained before the companion animal moves onto the main body container 11 and the measurements from the weight scales 2 obtained after the companion animal moves onto the main body container 11.

Meanwhile, the approximate weight measurement control unit 24a1 in the weight measurement control unit 24a performs the following control to measure the weight of excrete of the companion animal.

If the weight when the companion animal has moved down from the main body container 11 is larger than the base value BA (i.e., a positive value with the base value as reference 0) and smaller than the threshold weight, the threshold weight determining unit 24b1 determines that the companion animal has urinated and/or defecated. The approximate weight measurement control unit 24a1 determines the weight of the excreta on the basis of the amount of change in the measurements. Specifically, the approximate weight measurement control unit 24a1 subtracts the base value BA from the measurements taken after the companion animal urinates and/or defecates, to determine the weight of the excreted urine and/or feces.

The control unit 21, in the present embodiment, stores the measurements on the body or excreta weight of the companion animal obtained from the weight scales 2 in the memory unit 25 as shown in FIG. 4. The measurements include both the aforementioned approximate weight and a classified weight (described later in detail).

The control device 20A then sends the weight measurement stored in the memory unit 25 to, for example, a smartphone 4 via the communications unit 27 capable of Bluetooth® or like near-field communications. This configuration enables data transmission to a cloud 5 (group of servers) connected to the Internet.

The power supply unit 26 feeds power to various components of the control device 20A including the amplifier 22, the A/D converter 23, the CPU 24, the memory unit 25, and the communications unit 27. The power supply unit 26 may be, for example, a rechargeable battery or a dry-cell battery. As a further alternative, the power supply unit 26 may be an external power supply device.

The companion animal litter box 1A described above is a mere example of toilets for companion animals. In an aspect of the present invention, the companion animal litter box 1A may be another type of toilet for companion animals so long as the companion animal litter box 1A includes a weight scale and a microcomputer that is the control unit 21 including the amplifier 22, the A/D converter 23, and the CPU 24.

Configuration for Obtaining Weight with High Precision by Using General-Purpose Amplifier and A/D Converter

The control unit 21 including a microcomputer with the built-in CPU 24 includes the general-purpose amplifier 22 and A/D converter 23, to measure the weight of the body and excreta of the companion animal in the companion animal litter box 1A configured as above. These general-purpose amplifier 22 and A/D converter 23 however do not provide high-precision, high-resolution performance. Accordingly, the weight scale in accordance with the present embodiment is so configured as to readily achieve high-precision weight measurement at low cost by using such a general-purpose amplifier 22 and A/D converter 23.

Referring to (a), (b), and (c) of FIG. 5, a common method of measuring weight that involves the use of a load cell, the amplifier 22, and the A/D converter 23 will be first described as a method of measuring weight that involves the use of the general-purpose amplifier 22 and A/D converter 23. Portion (a) of FIG. 5 is a graph representing an output of a load cell, (b) of FIG. 5 is a graph representing an output of the amplifier 22, and (c) of FIG. 5 is a graph representing an output of the A/D converter 23.

As shown in FIG. 4, to measure weight by using the weight scales 2, the amplifier 22 amplifies an output voltage of a load cell, the A/D converter 23 converts the amplified voltage from analog to digital, and the CPU 24 processes the converted voltage value. For this purpose, the amplification factor and offset of the amplifier 22 and the resolution of the A/D converter 23 are specified in accordance with a measurable range (i.e., measurement range) and a precision level.

Specifically, as shown in (a) of FIG. 5, as an example, the load cell in the weight scale 2 is set up, for example, to output 10 mV for a rated load of 20 kg. The amplifier 22 amplifies this output voltage of the load cell. Under such settings, the output voltage of the load cell may go negative for a light load as indicated by a dash-dot line in (b) of FIG. 5. Accordingly, in the amplifier 22, the characteristic line is offset as indicated by a dash-double-dot line in (b) of FIG. 5, to output a positive value for the minimum load value (=0 kg). The amplifier 22 thus amplifies, by, for example, an amplification factor a, the voltage represented by the offset straight line representing the relationship between the load and the output voltage of the load cell, thereby generating the solid line in (b) of FIG. 5 (amplified straight line). The amplification factor a is equal to 10 in this example.

Next, the output voltage of the amplifier 22 is fed to the A/D converter 23 where the output voltage (analog data) of the amplifier 22 is converted to digital values with a resolution of b. Assume here that the resolution b is equal to 10 bits as an example. That the resolution b is equal to 10 bits means that if the A/D converter 23 has an input range of, for example, 0 to 150 mV, this input range is equally divided by 2∧b (2 to the b-th power)=2∧10 for digitization and conversion to a weight. Through these procedures, for example, a weight of 10 kg and a weight of 5 kg are obtained for A and B respectively as indicated by a solid line in (c) of FIG. 5.

The amplifier 22 and the A/D converter 23 need to have high precision and high resolution capabilities respectively to achieve high precision across a wide measurement range according to the measurement principles described above. Meanwhile, current microcomputers with a built-in CPU 24, often including general-purpose amplifiers and A/D converters, do not provide high-precision, high-resolution performance. Some A/D converters are capable of a high resolution of, for example, 24 bits, but they are costly.

The present embodiment accordingly provides a weight scale capable of substantially high-precision, high-resolution measurement at low cost by means of two rounds of measurements with different measurement ranges.

A description will be given of a method capable of this substantially high-precision, high-resolution measurement with reference to (a) and (b) of FIG. 6. Portion (a) of FIG. 6, illustrating how two rounds of measurements are performed for a high precision weight measurement using the weight scales 2 in the companion animal litter box 1A, is a graph representing an output of the amplifier 22 when a first measurement of 10 kg is obtained by using a load cell that has a rating of 20 kg, and (b) of FIG. 6 is a graph representing an output of the A/D converter 23.

In the first round of measurement, body weight is measured by the method illustrated in (a), (b), and (c) of FIG. 5. The measurement obtained in the first round of measurement will be referred to as the first measurement. The amplifier 22 is switched to another measurement range for a second round of body weight measurement in the present embodiment.

Assume that a first measurement of 10 kg is obtained in the first round of weight measurement as an example. In response to this, a second round of weight measurement is performed in the present embodiment by narrowing down the range to around the first measurement. Specifically, the characteristic line of the amplifier 22 is offset, and its amplification factor is readjusted, such that the output of the amplifier 22 for the range of approximately the first measurement plus and minus a few kilograms falls in the input range of the A/D converter 23 as much as possible. The output of the amplifier 22 may alternatively fall in a prescribed range (e.g., 0 to 100 mV) of the entire input range (e.g., 0 to 150 mV) of the A/D converter 23 in such a manner that a measurement is obtained even if the measurement target has a weight that slightly exceeds the rated weight (20 kg). For instance, the characteristic line of the amplifier 22 is offset toward the negative (−) domain as indicated by a dash-double-dot line in (a) of FIG. 6 from the output voltage of the load cell indicated by a dash-dot line in (a) of FIG. 6. The measurement range of the amplifier 22 is then reset to 5 kg to 15 kg, and the amplification factor a of the amplifier 22 is reset to 20, as opposed to 10 in the first round of weight measurement.

These offset and resetting procedures produce an amplified straight line indicated by a solid line in (a) of FIG. 6. Next, similarly to the first round of weight measurement, assuming that the A/D converter 23 has an input range of, for example, 0 to 150 mV, this input range is equally divided by 2∧b (2 to the b-th power)=2∧10 for digitization and conversion to weights as shown in (b) of FIG. 6. A weight value of 10 kg is hence obtained as shown in (b) of FIG. 6, in which case the measurement precision increases to twice that of the first round of weight measurement.

Next, a description will be given similarly of a second round of weight measurement with reference to (a) and (b) of FIG. 7, assuming that the first measurement from the first round of weight measurement is 5 kg as an example. Portion (a) of FIG. 7, illustrating how two rounds of measurements are performed for a high precision weight measurement using the weight scales 2 in the companion animal litter box 1A, is a graph representing an output of the amplifier 22 when a measurement of 5 kg is obtained in a first stage by using a load cell that has a rating of 20 kg, and (b) of FIG. 7 is a graph representing an output of the A/D converter 23.

In the first round of weight measurement, weight is measured by the method illustrated in (a), (b), and (c) of FIG. 5. The first measurement obtained in the first round of weight measurement is 5 kg. The measurement range of the amplifier 22 is therefore reset to 0 kg to 10 kg for weight measurement in the second round of weight measurement.

If the first measurement is equal to 5 kg, the measurement is small. The characteristic line of the amplifier 22 is therefore offset toward the positive (+) domain as indicated by a dash-double-dot line in (a) of FIG. 7 from the output voltage of the load cell indicated by a dash-dot line in (a) of FIG. 7. The amplification factor of the amplifier 22 is then reset to 20, as opposed to 10 in the first stage.

These offset and resetting procedures produce an amplified straight line indicated by a solid line in (a) of FIG. 7. Next, similarly to the first round of weight measurement, assuming that the A/D converter 23 has an input range of, for example, 0 to 150 mV, this input range is equally divided by 2∧b (2 to the b-th power)=2∧10 for digitization and conversion to weights as shown in (b) of FIG. 7. A weight value of 5 kg is hence obtained as shown in (b) of FIG. 7, where the measurement precision increases to twice that of the first round of weight measurement.

### High-Precision Weight Measurement of Body or Excreta Weight in Companion Animal Litter Box

A description will be given here of a flow of two rounds of weight measurements with different measurement ranges for the measurement of either one or both of body weight and excreta weight in the companion animal litter box 1A in accordance with the present embodiment, with reference to FIGS. 1 and 8. FIG. 1 is a flow chart representing a flow of measurement of the body or excreta weight of the measurement-target companion animal with high precision. FIG. 8 is a graph representing a relationship between time and weight when the body or excreta weight of the measurement-target companion animal is measured on the weight scales 2 in the companion animal litter box 1A.

To measure the body or excreta weight of the companion animal on the weight scales 2, the current value outputted from the weight scales 2 is monitored as shown in FIG. 1 (S1). If neither the companion animal nor excreta, one of which is going to be a measurement target, is in the main body container 11 during the monitoring, the weight scales 2 give a reading equal to the base value BA. The base value BA is the tare weight of the main body container 11 that includes the scale tray 12 and the litter tray 13 containing the absorbent sheet 14.

If there occurs an increase from the base value BA during the monitoring of the value outputted from the weight scales 2, the CPU 24 detects that the measurement target is in the main body container 11 (S2). The weight scales 2 then measure the weight of the measurement target (S3). In this case, the weight scales 2 measure the weight using a maximum measurement range specified for body weight measurement as a measurement range. This measurement is implemented by the approximate weight measurement control unit 24a1. Specifically, since the load cell has a rating of 20 kg in the present embodiment, the measurement ranges of the amplifier 22 and the A/D converter 23 are also from 0 to 20 kg. The amplification factor of the amplifier 22 is, for example, 10.

At the start of the measurement, the threshold weight determining unit 24b1 determines whether or not the measurement is greater than or equal to a threshold weight (S4). The threshold weight has a value between the body weight of the companion animal and the weight of excreta of the companion animal and is equal to, for example, 500 grams in the present embodiment. Therefore, if the approximate weight measurement control unit 24a1 gives a first measurement that is greater than or equal to the threshold weight, body weight is going to be measured. On the other hand, if the first measurement is smaller than the threshold weight and has a positive value, excreta weight is going to be measured.

These procedures are illustrated in FIG. 8, where if there is anything in the companion animal litter box 1A, either a body weight measurement or an excreta weight measurement is going to be selectively performed.

If the threshold weight determining unit 24b1 determines in step S4 in FIG. 1 that the measurement is greater than or equal to the threshold weight, body weight is going to be measured (S5).

Accordingly, for example, the classified weight measurement control unit 24a2 sets up the amplifier 22 for a preset measurement range and a preset amplification factor that match the body weight of the companion animal in the present embodiment, to perform another weight measurement (S6). Specifically, the classified weight measurement control unit 24a2 causes the amplifier 22 to amplify the output voltage of the load cell with the preset measurement range and the preset amplification factor and the A/D converter 23 to convert the output of the amplifier 22 from analog to digital, to obtain a weight value of the measurement target. The measurement obtained is then taken as the final body weight (S7).

As an example, the load cell of the present embodiment has a rating of 20 kg. The amplifier 22 has a maximum measurement range of, for example, 20 kg. The approximate weight measurement control unit 24a1 has been measuring weight approximately with the maximum measurement range of the amplifier 22 being set to 20 kg. There are cases however where the body weight of the companion animal is measured every day so that it is known that the companion animal is known to have a stable body weight of, for example, approximately 15 kg. In such cases, the amplifier 22 may be set up for a preset measurement range of, for example, from 10 kg to 20 kg and also for an amplification factor that matches this preset measurement range.

Next, if the threshold weight determining unit 24b1 determines in step S4 in FIG. 1 that the measurement is smaller than the threshold weight, the weight of excreta is going to be measured (S8).

Accordingly, for example, the classified weight measurement control unit 24a2 sets up the amplifier 22 for a preset measurement range and a preset amplification factor that match the weight of excreta of the companion animal in the present embodiment, to perform another weight measurement (S9). Specifically, the classified weight measurement control unit 24a2 causes the amplifier 22 to amplify an output voltage of the load cell with the preset measurement range and the preset amplification factor and the A/D converter 23 to convert an output of the amplifier 22 from analog to digital, to obtain a weight value of the measurement target. The measurement obtained is then taken as the final excreta weight (S10).

As an example, when the measurement object is excreta of the companion animal, and the excreta is known to have a stable weight of, for example, approximately 200 grams, the classified weight measurement control unit 24a2 may set up the amplifier 22 for a preset measurement range of, for example, from 10 grams to 300 grams and an amplification factor that matches this preset measurement range.

These procedures enable easy setting of the measurement range and the amplification factor of the amplifier 22 that match the body or excreta weight of the companion animal. These appropriate settings of the measurement range and the amplification factor that match the measurement of the body weight of the companion animal and the measurement of the weight of excreta of the companion animal respectively produce measurements with suitable significant digits.

The classified weight measurement control unit 24a2 has been described as setting up the amplifier 22 for a preset measurement range and a preset amplification factor to perform another weight measurement for a high precision measurement of the body or excreta weight of the companion animal.

There are however other methods available for changing the measurement range, for example.

For instance, the classified weight measurement control unit 24a2 may, as a variation example, set the measurement range of the amplifier 22 in the following manner.

An approximate weight of the body or excreta of the companion animal is known from the first companion animal body or excreta weight measurement performed by the approximate weight measurement control unit 24a1. Accordingly, the measurement range may be set to values near the approximate weight of the body or excreta weight of the companion animal.

For instance, the classified weight measurement control unit 24a2 resets the measurement range of the amplifier 22 to a range near the first measurement on the basis of the approximate, first measurement. In other words, the measurement range of the amplifier 22 and the measurement range of the A/D converter 23 for the second round of weight measurement are set respectively to less than the measurement range of the amplifier 22 and the measurement range of the A/D converter 23 that are used in obtaining the approximate weight.

To describe it in more detail, the measurement range of the amplifier 22 for the second round of measurement extends across the first measurement, is narrower than the measurement range of the amplifier 22 for the first round of weight measurement, and falls entirely in the measurement range of the amplifier 22 for the first round of weight measurement. A similar description applies to the measurement range of the A/D converter 23. If the first measurement is 10 kg, for example, the measurement range of the amplifier 22 is reset to 5 to 10 kg, and the amplification factor a of the amplifier 22 is reset to 20, as opposed to 10 in the first round of weight measurement. The offset and amplification factor of the amplifier 22 are so determined that the amplifier 22, when set up for the measurement range (5 to 15 kg) for the second round of weight measurement, makes an output that matches the prescribed input range (0 to 100 mV) of the A/D converter 23.

Weight is measured again under these settings (S6). The measurement obtained in the second round of weight measurement is then taken as the final body weight (S7).

As an example, if the measurement range of the amplifier 22 and the measurement range of the A/D converter 23 are set to 0 to 20 kg (Δ=20 kg) for the first round of weight measurement and to 5 to 15 kg (Δ=10 kg) for the second round of weight measurement, a measurement is obtained with twice the precision. As another example, if the measurement range of the amplifier 22 and the measurement range of the A/D converter 23 are set to 0 to 20 kg (Δ=20 kg) for the first round of weight measurement and to 7.5 to 12.5 kg (Δ=5 kg) for the second round of weight measurement, a measurement is obtained with 4 times the precision.

To give a general solution, a measurement is obtained with n times the precision if the measurement range of the amplifier 22 and the measurement range of the A/D converter 23 are set to Δx kg for the first round of weight measurement and to Δy=(Δx/n) kg for the second round of weight measurement.

Next, if the threshold weight determining unit 24b1 determines in step S4 in FIG. 1 that the measurement is smaller than the threshold weight, the weight of excreta is going to be measured (S8). In this case, the measurement range of the amplifier 22 is reset to a range near the first measurement on the basis of the first measurement. In other words, the measurement range of the amplifier 22 and the measurement range of the A/D converter 23 for the second round of weight measurement are set respectively to less than the measurement range of the amplifier 22 and the measurement range of the A/D converter 23 for the first round of measurement. To describe it in more detail, the measurement range of the amplifier 22 for the second round of measurement extends across the first measurement, is narrower than the measurement range of the amplifier 22 for the first round of weight measurement, and falls entirely in the measurement range of the amplifier 22 for the first round of weight measurement. A similar description applies to the measurement range of the A/D converter 23. If the first measurement is 200 grams, for example, the measurement range of the amplifier 22 is reset to, for example, 0 to 1000 grams. The amplification factor a of the amplifier 22 is reset to 200, as opposed to 10 in the first round of weight measurement. The offset and amplification factor of the amplifier 22 are so determined that the amplifier 22, when set up for the measurement range (0 to 1000 grams) for the second round of weight measurement, makes an output that matches the prescribed input range (0 to 100 mV) of the A/D converter 23.

Weight is measured again under these settings (S9). The measurement obtained in the second round of weight measurement is then taken as the final excreta measurement (S10). In the aforementioned example where the measurement range of the amplifier 22 and the measurement range of the A/D converter 23 are set to 0 to 20 kg (Δ=20 kg) for the first round of weight measurement and to 0 to 1000 grams (Δ=1000 grams) for the second round of weight measurement, a measurement is obtained with 20 times the precision.

The weight scales 2 in accordance with the present embodiment are provided with, for example, a load cell as a load sensor, the amplifier 22 as an amplifier, the A/D converter 23 as an A/D converter, and the CPU 24 as a control unit for controlling these components to calculate the weight of the measurement target, as described here. The CPU 24 includes: the determining unit 24b configured to determine whether the measurement target is a heavy object or a light object that is lighter in weight than the heavy object; and the classified weight measurement control unit 24a2 configured to set up the amplifier 22, based on the determining as to whether the measurement target is the heavy object or the light object, for a measurement range narrower than a maximum measurement range of the amplifier 22 and also for an amplification factor larger than an amplification factor used with the maximum measurement range, so as to match the heavy object or the light object, and thereafter cause the amplifier 22 to amplify an output voltage of the load cell and the A/D converter 23 to convert an output of the amplifier 22 from analog to digital, to obtain a weight value of the measurement target.

In the present configuration, a weight scale includes a load sensor, an amplifier, an A/D converter, and a control unit that controls these components to calculate weight of a measurement target.

In the present embodiment, first, the determining unit 24b determines whether the measurement target is a heavy object or a light object that is lighter in weight than the heavy object. The classified weight measurement control unit 24a2 then sets up the amplifier 22, based on the determining as to whether the measurement target is the heavy object or the light object, for a measurement range narrower than a maximum measurement range of the amplifier 22 and also for an amplification factor larger than an amplification factor used with the maximum measurement range, so as to match the heavy object or the light object, and thereafter causes the amplifier 22 to amplify an output voltage of the load cell and the A/D converter 23 to convert an output of the amplifier 22 from analog to digital, to obtain a weight value of the measurement target.

This configuration enables the determining unit 24b to determine whether the measurement target is a heavy object or a light object even if general-purpose amplifiers and A/D converters are used that do not provide high-precision, high-resolution performance. It is therefore known whether the measurement target is a heavy object or a light object. The measurement range of the amplifier 22 can be narrowed down to a measurement range narrower than the maximum measurement range, so that the amplifier 22 can be set up for an amplification factor larger than an amplification factor used with the maximum measurement range.

As a result, the weight value of the measurement target obtained by the classified weight measurement control unit 24a2 is more precise than the weight value of the measurement target obtained in a weight measurement performed with the amplifier 22 being set up for the maximum measurement range thereof.

To obtain this highly precise weight value, the present embodiment simply first classifies the measurement target as either a heavy object or a light object and uses a general-purpose amplifier and A/D converter that do not provide high-precision, high-resolution performance with this narrower measurement range setting, to measure weight. The configuration is thus capable of substantially high-precision, high-resolution measurement without having to use expensive products.

The present embodiment can hence provide the weight scales 2 capable of improving measurement precision at low cost in both heavy object measurement and light object measurement.

A method of measuring weight in accordance with the present embodiment determines the weight of a measurement target by using, for example, a load cell as a load sensor, the amplifier 22 as an amplifier, and the A/D converter 23 as an A/D converter. Specifically, the method includes the determining step of determining whether the measurement target is a heavy object or a light object that is lighter in weight than the heavy object, wherein the method sets up the amplifier 22, based on the determining as to whether the measurement target is the heavy object or the light object, for a measurement range and an amplification factor, so as to match the heavy object or the light object, and thereafter causes the amplifier 22 to amplify an output voltage of the load cell and the A/D converter 23 to convert an output of the amplifier 22 from analog to digital, to obtain a weight value of the measurement target. The present embodiment can therefore provide a method of measuring weight capable of improving measurement precision at low cost in both heavy object measurement and light object measurement.

In the weight scales 2 in accordance with the present embodiment, the CPU 24 includes the approximate weight measurement control unit 24a1 configured to set up the amplifier 22 for a first measurement range that is equal to the maximum measurement range and a first amplification factor that matches the maximum measurement range and cause the amplifier 22 to amplify an output voltage of the load cell and the A/D converter 23 to convert an output of the amplifier 22 from analog to digital, to obtain an approximate weight measurement of the measurement target. This configuration is capable of approximate weight measurement on the measurement target albeit with moderate precision.

In the weight scales 2 in accordance with the present embodiment, the determining unit 24b includes the threshold weight determining unit 24b1 configured to determine whether or not the approximate weight is larger than a predetermined threshold weight, to determine whether the measurement target is a heavy object or a light object.

This configuration enables the threshold weight determining unit 24b1 to determine whether or not the approximate weight obtained in the first round of weight measurement is larger than a predetermined threshold weight. The threshold weight may be specified to have a value that falls between the heavy object and the light object.

This specification enables determining that the measurement target is a heavy object when the approximate weight is larger than the threshold weight and determining that the measurement target is a light object when the approximate weight is smaller than the threshold weight. Therefore, the configuration can readily distinguish between heavy object measurement and light object measurement.

In the weight scales 2 in accordance with the present embodiment, the classified weight measurement control unit 24a2 can set up the amplifier for a preset measurement range and a preset amplification factor that match the heavy object or the light object and thereafter cause the amplifier to amplify an output voltage of the load sensor and the A/D converter to convert an output of the amplifier from analog to digital, to obtain a weight value of the measurement target. The preset measurement range may be specified, for example, to be a prescribed range that matches the classification as being the heavy object or the light object. The prescribed range may be specified, for example, to be a range from zero to a value smaller than the threshold weight and a range from a value greater than or equal to the threshold weight to the maximum measurement range, the preset measurement range having the threshold weight as a boundary.

This configuration enables easy setting of the measurement range and the amplification factor of the amplifier 22 so that the measurement range and the amplification factor match the heavy object or the light object.

In the weight scales 2 in accordance with the present embodiment, the classified weight measurement control unit 24a2 sets up the amplifier 22 for a second measurement range narrower than the first measurement range used in the approximate weight measurement and a second amplification factor larger than the first amplification factor, so as to match a heavy object (i.e., the body weight of the companion animal) or a light object (i.e., the weight of excreta of the companion animal) and thereafter causes the amplifier 22 to amplify an output voltage of the load cell and the A/D converter 23 to convert an output of the amplifier 22 from analog to digital, to obtain a second weight value of the measurement target.

This method of measurement enables setting to a measurement range near the first approximate weight in body weight measurement for the second round of weight measurement if the first round of weight measurement has determined that the body weight of the companion animal is going to be measured. Meanwhile, the method enables setting to a measurement range near an approximate weight of a light object for the second round of weight measurement if the first round of weight measurement has determined that the weight of excreta is going to be measured. This suitable setting to a narrower measurement range renders the second weight value more precise, regardless of whether the measurement target is the body weight of the companion animal or the weight of excreta of the companion animal.

The companion animal litter box 1A as an animal toilet in accordance with the present embodiment includes the weight scales 2 in accordance with the present embodiment to measure the weight of at least either the companion animal or its excreta or both. The present embodiment can thus provide the companion animal litter box 1A including a weight scale capable of improving measurement precision at low cost in both measurement of a heavy object (i.e., the body weight of the companion animal) and measurement of a light object (i.e., the weight of excreta of the companion animal).

### Embodiment 2

The following will describe another embodiment of the present invention with reference to FIGS. 9 to 11. The present embodiment has the same structure and configuration as does Embodiment 1 unless otherwise mentioned explicitly. In addition, for convenience of description, members of the present embodiment that have the same function as members shown in drawings for Embodiment 1 are indicated by the same reference numerals, and description thereof is omitted.

In the companion animal litter box 1A in accordance with Embodiment 1, whether the measurement target is the body weight of the companion animal or the weight of excreta of the companion animal is determined by the threshold weight determining unit 24b1 in the determining unit 24b determining whether or not the measurement obtained in the first round of weight measurement is greater than or equal to a threshold weight. In contrast, a companion animal litter box 1B in accordance with the present embodiment differs in that a load cell includes an acceleration sensor 3 and also that whether the measurement target is the body weight of the companion animal or the weight of excreta of the companion animal is determined depending on whether or not the acceleration of vibration caused by the measurement target is greater than or equal to a threshold acceleration. The acceleration sensor 3 only needs to detect the acceleration of vibration of, for example, the scale tray 12 and the main body container 11 caused by a companion animal on the scale tray 12 and is not necessarily provided in the load cell.

A description will be given of a configuration of the companion animal litter box 1B in accordance with the present embodiment with reference to FIG. 9. FIG. 9 is a block diagram of a configuration of a control device 20B for the companion animal litter box 1B in relation to the weight scales 2 in accordance with the present embodiment.

In the control device 20B in the companion animal litter box 1B in accordance with the present embodiment, the weight scales 2 include the acceleration sensor 3 as shown in FIG. 9. The acceleration sensor 3 is configured so as to detect as acceleration the magnitude of vibration based on the magnitude of a load exerted by the measurement target on the load cell. In other words, the acceleration sensor 3 detects the acceleration caused by vibration of, for example, the scale tray 12 and the main body container 11 caused by a companion animal on the scale tray 12.

The control device 20B includes a threshold acceleration determining unit 24b2 in the determining unit 24b in the CPU 24. The threshold acceleration determining unit 24b2 performs a judgment for determining whether the measurement target is the body weight of the companion animal or the weight of excreta of the companion animal Specifically, the threshold acceleration determining unit 24b2 determines, by means of a threshold acceleration, whether a companion animal or excreta is currently in the main body container 11. The threshold acceleration is specified to such a value as to distinguish between an animate companion animal and inanimate excreta. A companion animal in the main body container 11 causes vibration (in other words, causes a large acceleration). On the other hand, if there is only excreta in the main body container 11, vibration hardly occurs (acceleration is small).

The companion animal litter box 1B is otherwise configured in the same manner as the companion animal litter box 1A in accordance with Embodiment 1, and description thereof is omitted.

A description will be given here of a flow of two rounds of weight measurements with different measurement ranges for the measurement of either one or both of body weight and excreta weight in the companion animal litter box 1B configured as above, with reference to FIG. 10 and (a) and (b) of FIG. 11. FIG. 10 is a flow chart representing a flow of measurement of the body or excreta weight of the measurement-target companion animal by using the weight scales 2 in the companion animal litter box 1B. Portion (a) of FIG. 11 is a graph representing a relationship between time and weight when the body or excreta weight of the measurement-target companion animal is measured, and (b) of FIG. 11 is a graph representing a relationship between time and acceleration when the body or excreta weight of the measurement-target companion animal is measured.

To measure the body or excreta weight of the companion animal on the weight scales 2, the current value outputted from the weight scales 2 is monitored as shown in FIG. 10 (S21). If neither the companion animal nor excreta, one of which is going to be a measurement target, is in the main body container 11 during the monitoring, the weight scales 2 give a reading equal to the base value BA. The base value BA is the tare weight of the main body container 11 that includes the scale tray 12 and the litter tray 13 containing the absorbent sheet 14.

If there occurs an increase from the base value BA during the monitoring of the value outputted from the weight scales 2, the CPU 24 detects that the measurement target is in the main body container 11 (S22). The approximate weight measurement control unit 24a1 then measures the weight of the measurement target, and the acceleration sensor 3 acquires the acceleration of the load cell (S23). In this case, the weight scales 2 measure the weight using a maximum measurement range specified for body weight measurement as a measurement range. Specifically, since the load cell has a rating of 20 kg in the present embodiment, the measurement ranges of the amplifier 22 and the A/D converter 23 are also from 0 to 20 kg. The amplification factor of the amplifier 22 is 10.

At the start of the measurement, the threshold acceleration determining unit 24b2 determines whether or not the acceleration sensor 3 gives a value greater than or equal to a threshold acceleration (S24). Accordingly, if the acceleration has a value greater than or equal to the threshold acceleration, body weight is going to be measured. On the other hand, if the acceleration has a positive value smaller than the threshold acceleration, excreta weight is going to be measured. The value of the acceleration used in comparison by the threshold acceleration determining unit 24b2 may be, for example, a representative value of the acceleration in a prescribed period (e.g., an average or maximum absolute value).

These procedures are illustrated in (a) and (b) of FIG. 11, where if there is anything in the companion animal litter box 1A, a high acceleration is detected for body weight measurement, whereas a low acceleration is detected for excreta weight measurement.

If the threshold acceleration determining unit 24b2 determines in step S24 in FIG. 10 that the acceleration has a value greater than or equal to the threshold acceleration, body weight is going to be measured (S25).

Accordingly, the classified weight measurement control unit 24a2 sets up the amplifier 22 for a preset measurement range and a preset amplification factor that match, for example, the body weight of the companion animal, to perform another weight measurement (S26) as described in Embodiment 1. The measurement obtained is then taken as the final body weight (S27).

Next, if the threshold acceleration determining unit 24b2 determines in step S24 that the acceleration has a value smaller than the threshold weight, the weight of excreta is going to be measured (S28). Accordingly, the classified weight measurement control unit 24a2 may similarly set up the amplifier 22 for a preset measurement range and a preset amplification factor that match the weight of excreta of the companion animal, to perform another weight measurement (S29). The weight measurement obtained is then taken as the final weight of the excreta (S30).

In the present embodiment, similarly to Embodiment 1, the measurement range or the like is not necessarily a preset measurement range and a preset amplification factor and may be altered to a range near the approximate weight obtained in approximate weight measurement.

As described here, the weight scales 2 in the companion animal litter box 1B in accordance with the present embodiment are load cells (load sensors) and provided with the acceleration sensor 3 for detecting vibration based on the magnitude of the load exerted on the load cell by the measurement target. The determining unit 24b includes a threshold acceleration determining unit configured to determine whether or not the vibration based on the magnitude of the load exerted on the load cell by the measurement target is larger than a predetermined threshold acceleration, to determine whether the measurement target is a heavy object, that is, the body weight of the companion animal, or a light object, that is, excreta.

This configuration enables the acceleration sensor 3 to detect vibration based on the magnitude of the load exerted on the load cell by the measurement target. The threshold acceleration determining unit 24b2 also determines whether or not the vibration based on the magnitude of the load exerted on the load cell by the measurement target is larger than a predetermined threshold acceleration. The threshold acceleration may be specified to have a value that falls between the heavy object and the light object.

This specification enables determining that the measurement target is a heavy object (i.e., the body weight of a companion animal) when the approximate weight is larger than the threshold acceleration and determining that the measurement target is a light object (i.e., excreta of a companion animal) when the approximate weight is smaller than the threshold acceleration.

The configuration can therefore readily distinguish between heavy object measurement and light object measurement by means of the acceleration sensor 3.

### Embodiment 3

The following will describe a further embodiment of the present invention with reference to FIGS. 12 and 13. The present embodiment has the same structure and configuration as Embodiments 1 and 2 unless otherwise mentioned explicitly. In addition, members of the present embodiment that have the same function as members shown in drawings for Embodiments 1 and 2 are indicated by the same reference numerals, and description thereof is omitted.

In the companion animal litter box 1A in accordance with Embodiment 1 and the companion animal litter box 1B in accordance with Embodiment 2, either the threshold weight determining unit 24b1 or the threshold acceleration determining unit 24b2 determines whether the measurement target is the body or excreta weight of the companion animal, to measure weight in accordance with whether the measurement target is the body or excreta weight. In contrast, a companion animal litter box 1C in accordance with the present embodiment differs in that the body weight and the excreta weight are automatically and successively measured by exploiting the timings of the measurements.

A description will be given of a flow of a weight measurement process of successively measuring the body and excreta weights in the companion animal litter box 1C in accordance with the present embodiment, with reference to FIGS. 12 and 13. FIG. 12 is a flow chart representing a flow of successively measuring the body and excreta weights of the measurement-target companion animal by using the weight scales 2 in the companion animal litter box 1C in accordance with the present embodiment. FIG. 13 is a graph representing a relationship between time and weight when the body and excreta weights of the measurement-target companion animal are measured.

To successively measure the body and excreta weights of the companion animal on the weight scales 2, the current value outputted from the weight scales 2 is monitored as shown in FIG. 12 (S41). If neither the companion animal nor excreta, one of which is going to be a measurement target, is in the main body container 11 during the monitoring, the weight scales 2 give a reading equal to the base value BA. The base value BA is the tare weight of the main body container 11 that includes the scale tray 12 and the litter tray 13 containing the absorbent sheet 14. The weight scales 2, when standing by, need only to be capable of measuring at least a range of weight from the base value BA to a weight in excess of a threshold weight. The weight scales 2, when standing by, may measure weight by using a maximum measurement range specified for body weight measurement as a measurement range. Specifically, since the load cell has a rating of 20 kg in the present embodiment, the measurement ranges of the amplifier 22 and the A/D converter 23 are also set to 0 to 20 kg. The amplification factor of the amplifier 22 is set to 10.

Next, if there occurs a change in the value outputted from the weight scales 2 from the base value BA to a value greater than or equal to a threshold weight while the value outputted from the weight scales 2 is being monitored, the threshold weight determining unit 24b1 determines that the measurement target that is in the main body container 11 after the occurrence of the change is a companion animal (S42). The CPU 24 then detects that the measurement target is in the main body container 11, and the weight scales 2 measure the weight of the measurement target. At this time, the companion animal litter box 1C measures the body weight.

To measure the body weight, the amplifier 22 may be set up for a preset measurement range and a preset amplification factor that match, for example, the body weight of the companion animal as described in steps S5 to S7 in FIG. 1 in relation to Embodiment 1, to perform another weight measurement. The measurement obtained is then taken as the final body weight (S43).

Next, as the body weight measurement of the companion animal is completed, the value outputted from the weight scales 2 is monitored again. Then, a change in the value outputted from the weight scales 2 from a value greater than or equal to a threshold weight to a value smaller than the threshold weight indicates that the companion animal has moved down from the main body container 11 of the companion animal litter box 1C. A positive value outputted from the weight scales 2 that is larger than the base value BA indicates that there is something in the main body container 11. If the value outputted from the weight scales 2 has changed from a value greater than or equal to the threshold weight to a positive value smaller than the threshold weight, the threshold weight determining unit 24b1 determines that the measurement target that is in the main body container 11 after the occurrence of the change is excreta (S44).

Therefore, in the present embodiment, excreta measurement is continued. To measure the weight of excreta, the amplifier 22 may be set up for a preset measurement range and a preset amplification factor that match, for example, excreta of the companion animal as described in steps S8 to S10 in FIG. 1 in accordance with Embodiment 1, to perform another weight measurement. The measurement obtained is then taken as the final weight of excreta (S45).

These procedures are illustrated in FIG. 13, where if there occurs a change in the value outputted from the weight scales 2 from the base value BA to a greater than or equal to the threshold weight, the control unit 21 immediately measures the body weight of the companion animal. The control unit 21 is configured to immediately perform excreta measurement if the value outputted from the weight scales 2 changes from a value greater than or equal to the threshold value to a positive value smaller than the threshold weight.

Both the body and excreta weights are measured using a well-matched, narrow measurement range, to obtain a high-precision measurement.

In other words, the companion animal litter box 1C in accordance with the present embodiment is configured to determine, in accordance with the timing of the measurement, whether the measurement target is a heavy object or a light object and perform successive body and excreta weight measurements using individual, suitable sets of settings.

As described here, in the weight scales 2 in the companion animal litter box 1C in accordance with the present embodiment, there are two types of measurement targets, a heavy object (i.e., companion animal) and a light object (i.e., excreta). If the determining unit 24b determines that the measurement target is a heavy object (i.e., companion animal), the classified weight measurement control unit 24a2 specifies for the amplifier 22 a measurement range and an amplification factor that match the body weight of the companion animal and thereafter causes the amplifier 22 to amplify an output voltage of the load cell and the A/D converter 23 to convert an output of the amplifier 22 from analog to digital, to obtain a weight value of the companion animal. If the determining unit 24b determines that the measurement target is excreta in response to a decrease in the output voltage of the load cell, the classified weight measurement control unit 24a2 specifies for the amplifier 22 a measurement range and an amplification factor that match excreta and thereafter causes the amplifier 22 to amplify an output voltage of the load cell and the A/D converter 23 to convert an output of the amplifier 22 from analog to digital, to obtain a weight value of the excreta.

As a result, in an aspect of the present invention, the determining unit 24b can identify successive timings for the measurement of the body weight of the companion animal and the measurement of the excreta weight of the companion animal, to obtain a measurement with improved precision in each weight measurement process.

In the present embodiment, the determining unit 24b determines whether the measurement target is a companion animal or excreta, in which case the determining unit 24b may either the threshold weight determining unit 24b1 described in Embodiment 1 or the threshold acceleration determining unit 24b2 described in an embodiment.

### Software Implementation

The control block of the control devices 20A and 20B (particularly, the CPU 24 in the control unit 21) may be implemented by logic circuits (hardware) fabricated, for example, in the form of an integrated circuit (IC chip) and may be implemented by software run by a CPU (central processing unit).

In the latter form of implementation, the CPU 24 includes, among others: a CPU that executes instructions from programs or software by which various functions are implemented; a ROM (read-only memory) or like storage device (referred to as a “storage medium”) containing the programs and various data in a computer-readable (or CPU-readable) format; and a RAM (random access memory) into which the programs are loaded. The computer (or CPU) then retrieves and runs the programs contained in the storage medium, thereby achieving the object of the present invention. The storage medium may be a “non-transitory, tangible medium” such as a tape, a disc/disk, a card, a semiconductor memory, or programmable logic circuitry. The programs may be supplied to the computer via any transmission medium (e.g., over a communications network or by broadcasting waves) that can transmit the programs. The present invention encompasses data signals on a carrier wave that are generated during electronic transmission of the programs.

### GENERAL DESCRIPTION

The present invention, in aspect 1 thereof, is directed to a weight scale 2 including: a load sensor; an amplifier (amplifier 22); an A/D converter (A/D converter 23); and a control unit (CPU 24) that controls these components to calculate weight of a measurement target, the control unit (CPU 24) including: a determining unit 24b configured to determine whether the measurement target is a heavy object or a light object that is lighter in weight than the heavy object; and a classified weight measurement control unit 24a2 configured to set up the amplifier (amplifier 22), based on the determining as to whether the measurement target is the heavy object or the light object, for a measurement range narrower than a maximum measurement range of the amplifier and also for an amplification factor larger than an amplification factor used with the maximum measurement range, so as to match the heavy object or the light object, and thereafter cause the amplifier (amplifier 22) to amplify an output voltage of the load sensor and the A/D converter (A/D converter 23) to convert an output of the amplifier (amplifier 22) from analog to digital, to obtain a weight value of the measurement target.

In this configuration, the weight scale includes a load sensor, an amplifier, an A/D converter, and a control unit that controls these components to calculate weight of a measurement target.

Generally, this type of weight scale often includes a general-purpose amplifier and A/D converter that do not provide high-precision, high-resolution performance, in which case the weight scale is not capable of high-precision weight measurement if the amplifier is set up for a maximum measurement range thereof and an amplification factor used with the maximum measurement range. For instance, the weight of a heavy object, weighing, for example, 15 kg, can be measured with appreciable precision using a load cell with a rating of 20 kg. If the weight of an object, weighing 15.1 kg, is measured using the same load cell, the result will contain unreliable digits after the decimal point.

In addition, the weight of a light object, weighing, for example, 0.2 kg cannot be measured with appreciable precision using that load cell.

Accordingly, in an aspect of the present invention, first, the determining unit determines whether the measurement target is a heavy object or a light object that is lighter in weight than the heavy object. The classified weight measurement control unit then sets up the amplifier, based on the determining as to whether the measurement target is the heavy object or the light object, for a measurement range narrower than a maximum measurement range of the amplifier and also for an amplification factor larger than an amplification factor used with the maximum measurement range, so as to match the heavy object or the light object, and thereafter causes the amplifier to amplify an output voltage of the load sensor and the A/D converter to convert an output of the amplifier from analog to digital, to obtain a weight value of the measurement target.

This configuration enables the determining unit to determine whether the measurement target is a heavy object or a light object even if general-purpose amplifiers and A/D converters are used that do not provide high-precision, high-resolution performance. It is therefore known whether the measurement target is a heavy object or a light object. The measurement range of the amplifier can be narrowed down to a measurement range narrower than the maximum measurement range, so that the amplifier can be set up for an amplification factor larger than an amplification factor used with the maximum measurement range.

As a result, the weight value of the measurement target obtained by the classified weight measurement control unit is more precise than the weight value of the measurement target obtained in a weight measurement performed with the amplifier being set up for the maximum measurement range thereof.

To obtain this highly precise weight value, the present invention, in an aspect thereof, simply first classifies the measurement target as either a heavy object or a light object and uses a general-purpose amplifier and A/D converter that do not provide high-precision, high-resolution performance with this narrower measurement range setting, to measure weight. The configuration is thus capable of substantially high-precision, high-resolution measurement without having to use expensive products.

The configuration can hence provide a weight scale capable of improving measurement precision at low cost in both heavy object measurement and light object measurement.

In the weight scale 2 of aspect 2 of the present invention, the control unit (CPU 24) preferably further includes an approximate weight measurement control unit 24a1 configured to set up the amplifier (amplifier 22) for a first measurement range that is equal to the maximum measurement range and a first amplification factor that matches the maximum measurement range and cause the amplifier (amplifier 22) to amplify the output voltage of the load sensor and the A/D converter (A/D converter 23) to convert the output of the amplifier (amplifier 22) from analog to digital, to obtain an approximate weight measurement of the measurement target.

This configuration is capable of approximate weight measurement on the measurement target albeit with moderate precision.

In the weight scale 2 of aspect 3 of the present invention, the determining unit 24b includes a threshold weight determining unit 24b1 configured to determine whether or not the approximate weight is larger than a predetermined threshold weight, to determine whether the measurement target is the heavy object or the light object.

This configuration enables the threshold weight determining unit to determine whether or not the approximate weight obtained in the first round of weight measurement is larger than a predetermined threshold weight. The threshold weight may be specified to have a value that falls between the heavy object and the light object.

This specification enables determining that the measurement target is a heavy object when the approximate weight is larger than the threshold weight and determining that the measurement target is a light object when the approximate weight is smaller than the threshold weight. Therefore, the configuration can readily distinguish between heavy object measurement and light object measurement.

In the weight scale 2 of aspect 4 of The present invention, the classified weight measurement control unit sets up the amplifier based on the approximate weight for a second measurement range narrower than the first measurement range and a second amplification factor larger than the first amplification factor and thereafter causes the amplifier to amplify the output voltage of the load sensor and the A/D converter to convert an output of the amplifier from analog to digital, to obtain a weight value of the measurement target.

This method of measurement enables setting to a measurement range near an approximate weight of a heavy object for the second round of weight measurement if the first round of weight measurement has determined that the measurement target is a heavy object. Meanwhile, the method enables setting to a measurement range near an approximate weight of a light object for the second round of weight measurement if the first round of weight measurement has determined that the measurement target is a light object. This suitable setting to a narrower measurement range renders the second weight value more precise, regardless of whether the measurement target is a heavy object or a light object.

The weight scale 2 of aspect 5 of the present invention further includes an acceleration sensor 3 configured to detect vibration caused by the measurement target as an acceleration, wherein the determining unit 24b includes a threshold acceleration determining unit 24b2 configured to determine whether or not the acceleration detected by the acceleration sensor is larger than a predetermined threshold acceleration, to determine whether the measurement target is the heavy object or the light object.

This configuration enables the acceleration sensor to detect vibration exerted by the measurement target. The threshold acceleration determining unit in the control unit also determines whether or not the acceleration detected by the acceleration sensor is larger than a predetermined threshold acceleration.

The configuration can therefore readily distinguish between heavy object measurement and light object measurement by means of the acceleration sensor.

In the weight scale 2 of aspect 6 of the present invention, the classified weight measurement control unit 24a2 sets up the amplifier (amplifier 22) for a preset measurement range and a preset amplification factor that match the heavy object or the light object and thereafter causes the amplifier (amplifier 22) to amplify the output voltage of the load sensor (load cell) and the A/D converter (A/D converter 23) to convert an output of the amplifier (amplifier 22) from analog to digital, to obtain a weight value of the measurement target.

This configuration enables easy setting of the measurement range and the amplification factor of the amplifier so that the measurement range and the amplification factor match the heavy object or the light object. As an example, when the maximum measurement range is, for example, 20 kg, and a heavy object is known to have a stable weight of, for example, approximately 15 kg, the classified weight measurement control unit may set up the amplifier for a preset measurement range of, for example, 10 kg to 20 kg and an amplification factor that matches the preset measurement range. As another example, when the maximum measurement range is, for example, 20 kg, and a light object is known to have a stable weight of, for example, approximately 250 grams, the classified weight measurement control unit may the amplifier for a preset measurement range of, for example, 0 to 2000 grams and an amplification factor that matches the preset measurement range.

In the weight scale 2 of aspect 7 of the present invention, the determining unit determines that the measurement target is the heavy object when the approximate weight has changed from a base value to a value greater than or equal to the threshold weight and determines that the measurement target is the light object when the approximate weight has changed from a value greater than or equal to the threshold weight to a value smaller than the threshold weight.

This configuration enables the determining unit to determine, in accordance with the timing of a change in the approximate weigh, the measurement target is a heavy object or a light object.

If the output voltage of the load sensor has decreased, and the determining unit has successively determined that the measurement target is a light object, the classified weight measurement control unit sets the measurement range and the amplification factor of the amplifier to such values that match the light object, and thereafter causes the amplifier to amplify the output voltage of the load sensor and the A/D converter to convert an output of the amplifier from analog to digital, to obtain a weight value of the light object.

As a result, in an aspect of the present invention, the determining unit can identify successive timings for the measurement of the heavy object and the measurement of the light object, to obtain a measurement with improved precision in each weight measurement process.

The present invention, in aspect 8 thereof, is directed to a method of measuring weight of a measurement target by using a load sensor, an amplifier (amplifier 22), and an A/D converter (A/D converter 23), the method including the determining step of determining whether the measurement target is a heavy object or a light object that is lighter in weight than the heavy object, wherein the method sets up the amplifier, based on the determining as to whether the measurement target is the heavy object or the light object, for a measurement range narrower than a maximum measurement range of the amplifier and also for an amplification factor larger than an amplification factor used with the maximum measurement range, so as to match the heavy object or the light object, and thereafter causes the amplifier (amplifier 22) to amplify an output voltage of the load sensor and the A/D converter (A/D converter 23) to convert an output of the amplifier (amplifier 22) from analog to digital, to obtain a weight value of the measurement target.

This method can provide a method of measuring weight capable of improving measurement precision at low cost in both heavy object measurement and light object measurement

The present invention, in aspect 9 thereof, is directed to an animal litter box including the weight scale described above to measure weight of either an animal or excreta of the animal or both.

This configuration can provide an animal litter box including a weight scale capable of improving measurement precision at low cost in both heavy object measurement and light object measurement.

The present invention is not limited to the description of the embodiments above and may be altered within the scope of the claims. Embodiments based on a proper combination of technical means disclosed in different embodiments are encompassed in the technical scope of the present invention.

### REFERENCE SIGNS LIST

1A, 1B, 1C Companion Animal Litter Box (Animal Litter Box)
2 Weight Scale
3 Acceleration Sensor
4 Smartphone
11 Main Body Container
12 Scale Tray
13 Litter Tray
14 Absorbent Sheet
20A, 20C, 20C Control Device
21 Control Unit
22 Amplifier
23 A/D Converter
24 CPU (Control Unit)
24a Weight Measurement Control Unit
24a1 Approximate Weight Measurement Control Unit
24a2 Classified Weight Measurement Control Unit
24b Determining Unit
24b1 Threshold Weight Determining Unit
24b2 Threshold Acceleration Determining Unit
25 Memory Unit
27 Communications Unit

1. A weight scale comprising:
a load sensor;
an amplifier;
an A/D converter; and
a control unit that controls these components to calculate weight of a measurement target, the control unit including:
a determining unit configured to determine whether the measurement target is a heavy object or a light object that is lighter in weight than the heavy object; and
a classified weight measurement control unit configured to set up the amplifier, based on the determining as to whether the measurement target is the heavy object or the light object, for a measurement range narrower than a maximum measurement range of the amplifier and also for an amplification factor larger than an amplification factor used with the maximum measurement range, so as to match the heavy object or the light object, and thereafter cause the amplifier to amplify an output voltage of the load sensor and the A/D converter to convert an output of the amplifier from analog to digital, to obtain a weight value of the measurement target.

2. The weight scale according to claim 1, wherein the control unit further includes an approximate weight measurement control unit configured to set up the amplifier for a first measurement range that is equal to the maximum measurement range and a first amplification factor that matches the maximum measurement range and cause the amplifier to amplify the output voltage of the load sensor and the A/D converter to convert an output of the amplifier from analog to digital, to obtain an approximate weight measurement of the measurement target.

3. The weight scale according to claim 2, wherein the determining unit includes a threshold weight determining unit configured to determine whether or not the approximate weight is larger than a predetermined threshold weight, to determine whether the measurement target is the heavy object or the light object.

4. The weight scale according to claim 2, wherein the classified weight measurement control unit sets up the amplifier based on the approximate weight for a second measurement range narrower than the first measurement range and a second amplification factor larger than the first amplification factor and thereafter causes the amplifier to amplify the output voltage of the load sensor and the A/D converter to convert an output of the amplifier from analog to digital, to obtain a weight value of the measurement target.

5. The weight scale according to claim 1, further comprising an acceleration sensor configured to detect vibration caused by the measurement target as an acceleration, wherein the determining unit includes a threshold acceleration determining unit configured to determine whether or not the acceleration detected by the acceleration sensor is larger than a predetermined threshold acceleration, to determine whether the measurement target is the heavy object or the light object.

6. The weight scale according to claim 1, wherein the classified weight measurement control unit sets up the amplifier for a preset measurement range and a preset amplification factor that match the heavy object or the light object and thereafter causes the amplifier to amplify the output voltage of the load sensor and the A/D converter to convert an output of the amplifier from analog to digital, to obtain a weight value of the measurement target.

7. The weight scale according to claim 2, wherein the determining unit determines that the measurement target is the heavy object when the approximate weight has changed from a base value to a value greater than or equal to the threshold weight and determines that the measurement target is the light object when the approximate weight has changed from a value greater than or equal to the threshold weight to a value smaller than the threshold weight.

8. A method of measuring weight of a measurement target by using a load sensor, an amplifier, and an A/D converter, the method comprising:
the determining step of determining whether the measurement target is a heavy object or a light object that is lighter in weight than the heavy object; and
the weight value obtaining step of setting up the amplifier, based on the determining as to whether the measurement target is the heavy object or the light object, for a measurement range narrower than a maximum measurement range of the amplifier and also for an amplification factor larger than an amplification factor used with the maximum measurement range, so as to match the heavy object or the light object, and thereafter causing the amplifier to amplify an output voltage of the load sensor and the A/D converter to convert an output of the amplifier from analog to digital, to obtain a weight value of the measurement target.

9. An animal litter box comprising the weight scale according to claim 1 to measure weight of either an animal or excreta of the animal or both.
